(19) United States
(12) Patent Application Publication
(10) Pub. No.: US 2003/0107537 A1
(43) Pub. Date: Jun. 12, 2003

(54) Capacitive light emitting device panel

(75) Inventors: Hideo Ochi, Tsurugashima-shi (JP); Shinichi Ishizuka, Tsurugashima-shi (JP)

Correspondence Address: McGinn & Gibb, PLLC, Suite 200, 8321 Old Courthouse Road, Vienna, VA, 22182-3817, US

(73) Assignee: Pioneer Corporation, Tokyo (JP)

(21) Appl. No.: 10/231,171

(22) Filed: Aug. 30, 2002

(30) Foreign Application Priority Data
Sep. 3, 2001 (JP) 2001-265668

(51) Int. Cl. G09G 3/32

(52) U.S. Cl. 345/83

(57) ABSTRACT

A capacitive light emitting device panel having a plurality of pixels each of which is constructed by a red light emitting unit, a green light emitting unit, and a blue light emitting unit. A ratio of areas of light emitting surfaces of the red light emitting unit, green light emitting unit, and blue light emitting unit is set so that voltage differences among peak voltages of applied voltages to the red light emitting unit, green light emitting unit, and blue light emitting unit lie within a predetermined voltage range.

### BACKGROUND OF THE INVENTION

1. Field of the Invention

The present invention relates to a capacitive light emitting device panel of a color display.

2. Description of the Related Arts

As a capacitive light emitting device panel of a color display, an electroluminescence display panel in which a plurality of organic electroluminescence devices are arranged in matrix form has been known. Each pixel of the display panel is formed by light emitting units for individually emitting light of three colors of RGB. That is, as shown in FIG. 1, an electroluminescence display panel 1 is formed in a manner such that when it is seen from the obverse, a red light emitting unit 1R, a green light emitting unit 1G, and a blue light emitting unit 1B each having an equal area construct one group which forms one pixel, and a plurality of groups are repetitively arranged in the vertical and lateral directions.

In the red light emitting unit, green light emitting unit, and blue light emitting unit, however, differences occur among peak voltages which are applied in order to obtain target luminances or a white balance as shown in FIG. 2. This is because since light emission luminance characteristics due to differences of materials are different among electroluminescence devices having different light emission colors, differences occur among applied driving voltages. A driving voltage as a power voltage in a driving circuit is matched with the peak voltage of the red light emitting unit which needs the highest peak voltage, and the power voltage is individually dropped in the circuit, thereby producing the applied driving voltage of the green light emitting unit and the applied driving voltage of the blue light emitting unit. There is, consequently, a problem such that vain electric power consumption is caused in the driving circuit due to the voltage drop.

### OBJECTS AND SUMMARY OF THE INVENTION

It is, therefore, an object of the present invention to provide a capacitive light emitting device panel of a color display which can realize power saving.

According to the invention, there is provided a capacitive light emitting device panel having a plurality of pixels each of which is constructed by a red light emitting unit, a green light emitting unit, and a blue light emitting unit, wherein a ratio of areas of light emitting surfaces of the red light emitting unit, green light emitting unit, and blue light emitting unit is set so that voltage differences among peak voltages of applied voltages to the red light emitting unit, green light emitting unit, and blue light emitting unit lie within a predetermined voltage range.

### BRIEF DESCRIPTION OF THE DRAWINGS

FIG. 1 is a diagram showing light emitting surfaces of a red light emitting unit, a green light emitting unit, and a blue light emitting unit of each pixel of a conventional electroluminescence display panel;

FIG. 2 is a diagram showing a driving voltage and a peak voltage of each of the red light emitting unit, green light emitting unit, and blue light emitting unit;

FIG. 3 is a diagram showing light emitting surfaces of a red light emitting unit, a green light emitting unit, and a blue light emitting unit of each pixel of an electroluminescence display panel of the present invention;

FIG. 4 is a diagram showing a cross sectional structure in the lateral direction of the display panel in FIG. 3;

FIG. 5 is a diagram showing a cross sectional structure in the vertical direction of the display panel in FIG. 3;

FIG. 6 is a diagram showing a driving voltage and a peak voltage of each of the red light emitting unit, green light emitting unit, and blue light emitting unit in case of the panel in FIG. 3; and

FIG. 7 is a diagram showing a schematic construction of a driving circuit.

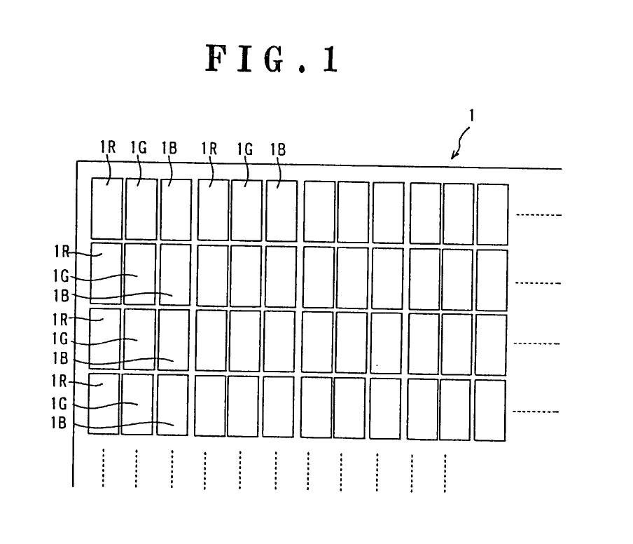

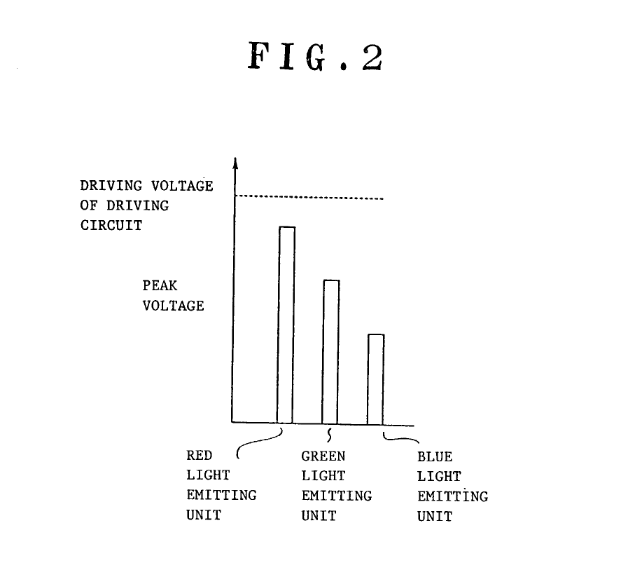

### DETAILED DESCRIPTION OF THE PREFERRED EMBODIMENT

An embodiment of the invention will be described in detail hereinbelow with reference to the drawings.

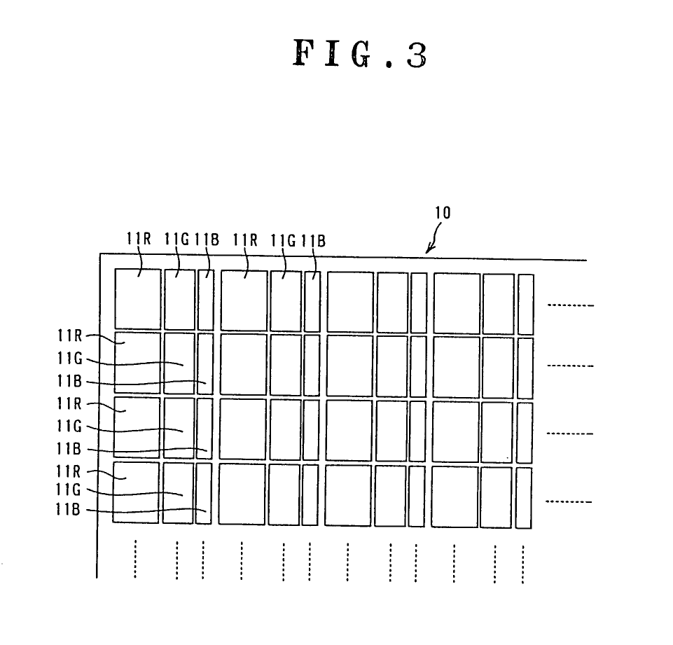

FIG. 3 shows a schematic construction of an electroluminescence display panel 10 of a color display according to the present invention. The electroluminescence display panel 10 is constructed in a manner such that a red (R) light emitting unit 11R, a green (G) light emitting unit 11G, and a blue (B) light emitting unit 11B form one pixel and those light emitting units are arranged in matrix form. As will be obviously understood from FIG. 3, areas of light emitting surfaces of the red light emitting unit 11R, green light emitting unit 11G, and blue light emitting unit 11B are different. Those areas decrease in order of the red light emitting unit 11R, green light emitting unit 11G, and blue light emitting unit 11B. Although the light emitting units are repeated in order of the red light emitting unit 11R, green light emitting unit 11G, and blue light emitting unit 11B in the lateral direction of the electroluminescence display panel 10, the light emitting units of the same color are continuously arranged in the vertical direction.

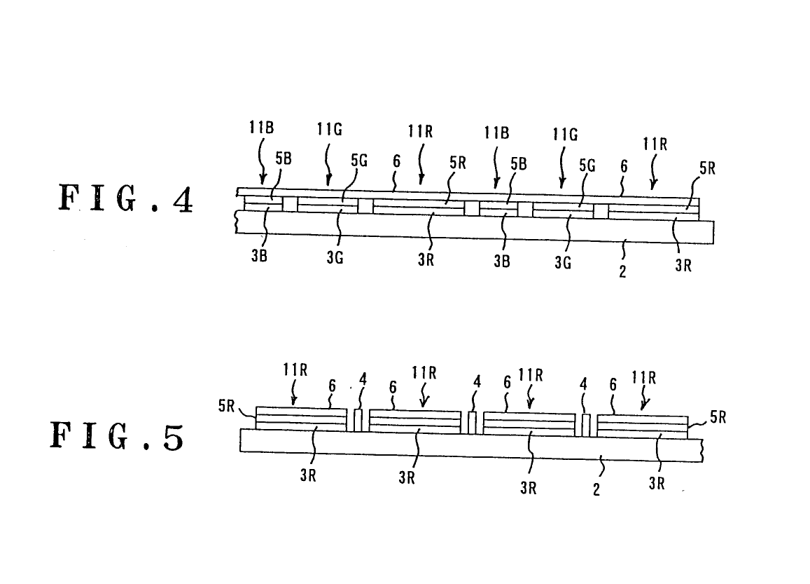

FIG. 4 is a cross sectional view in the lateral direction of the display panel 10 in FIG. 3. FIG. 5 is a cross sectional view in the vertical direction of the display panel 10 in FIG. 3. As shown in FIGS. 4 and 5, a substrate 2 of the electroluminescence display panel 10 is made of a transparent material such as glass. Anode electrodes 3R, 3G, and 3B each made of an indium oxide film (ITO) or the like are repetitively formed in parallel on the substrate 2. A width of anode electrode 3R corresponding to the red light emitting unit 11R is the largest. A width of anode electrode 3G corresponding to the green light emitting unit 11G is the second largest. A width of anode electrode 3B corresponding to the blue light emitting unit 11B is the smallest.

A plurality of partition walls 4 for separating the adjacent light emitting units 11R, 11G, and 11B are formed on the substrate 2 so as to be extended in the lateral direction. Intervals among the plurality of partition walls 4 are equal.

Organic electroluminescence (EL) media 5R, 5G, and 5B of thin films are formed on the anode electrodes 3R, 3G, and 3B of the substrate 2 separated by the partition walls 4, respectively. The medium 5R is used for the red light emitting unit 11R. The medium 5G is used for the green light emitting unit 11G. The medium 5B is used for the blue light emitting unit 11B. Each of the organic EL media 5R, 5G, and 5B is a single layer of an organic light emitting layer, a medium of a 3-layer structure comprising an organic hole transporting layer, an organic light emitting layer, and an organic electron transporting layer, a medium of a 2-layer structure comprising an organic hole transporting layer and an organic light emitting layer, or the like.

A cathode electrode 6 in rectilinear belt-shape is formed on each of the organic EL media 5R, 5G, and 5B. Portions including the organic EL media sandwiched by the anode electrodes 3R, 3G, and 3B and the cathode electrode 6 which cross each other correspond to the light emitting units 11R, 11G, and 11B.

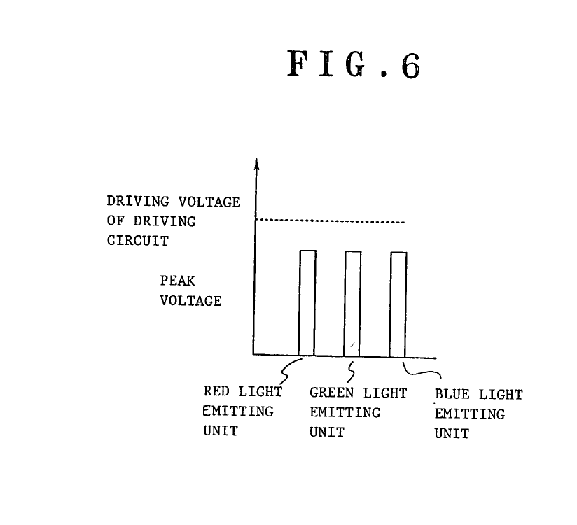

As mentioned above, the areas of the light emitting units 11R, 11G, and 11B decrease in order of the red light emitting unit 11R, green light emitting unit 11G, and blue light emitting unit 11B. The area ratio is determined so that differences among the peak voltages of the red light emitting unit 11R, green light emitting unit 11G, and blue light emitting unit 11B decrease when the electroluminescence display panel 10 is driven by a current. That is, the area ratio is set in a manner such that when the peak voltages which are applied to the red light emitting unit 11R, green light emitting unit 11G, and blue light emitting unit 11B are the same as shown in FIG. 6, light emission luminances of the red light emitting unit 11R, green light emitting unit 11G, and blue light emitting unit 11B are set to be almost constant. In the case of the equal area, the peak voltage is decreased by increasing the area of the red light emitting unit 11R whose peak voltage is high and, on the contrary, the peak voltage is increased by decreasing the area of the blue light emitting unit 11B whose peak voltage is low. It is desirable that the voltage difference of the peak voltage of each of R, G, and B is equal to or less than, for example, 2V.

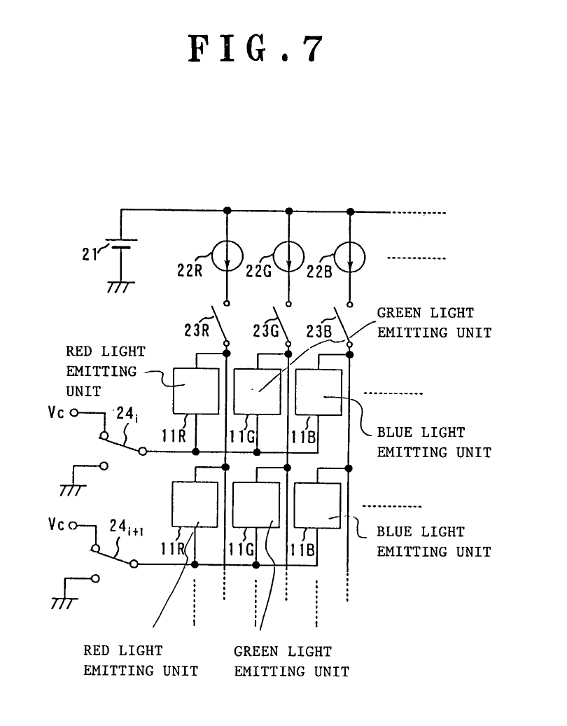

The driving circuit of the electroluminescence display panel 10 having the light emitting units 11R, 11G, and 11B whose areas set as mentioned above is schematically constructed as shown in, for example, FIG. 7 in a current driving system of a simple matrix. That is, the driving circuit has a power source 21, current sources 22R, 22G, and 22B, and switches 23R, 23G, 23B, 24ᵢ , and 24ᵢ₊₁. A positive terminal of the power source 21 is connected to an input terminal of each of the current sources 22R, 22G, and 22B so that a driving voltage as an output voltage of the power source 21 is used in common for RGB. An output terminal of the current source 22R is connected to a first electrode of the red light emitting unit 11R via the switch 23R. An output terminal of the current source 22G is connected to a first electrode of the green light emitting unit 11G via the switch 23G. An output terminal of the current source 22B is connected to a first electrode of the blue light emitting unit 11B via the switch 23B. The switches 23R, 23G, and 23B are turned on by a control circuit (not shown) when one of the light emitting units of the column including the light emitting units llR, 11G, and 11B of the electroluminescence display panel 10 is allowed to emit light. A current value of each of the current sources 22R, 22G, and 22B is individually controlled by the control circuit in accordance with a display color. The switches 24ᵢ, and 24ᵢ₊₁, are scanning switches for supplying a ground potential to second electrodes of the light emitting units 11R, 11G, and 11B upon scan selection in accordance with a scanning command from the control circuit and supplying a predetermined electric potential Vc to the second electrodes of the light emitting units 11R, 11G, and 11B upon non-selection.

As mentioned above, since the peak voltage which is applied to the red light emitting unit 11R can be decreased to a voltage lower than that of the conventional panel, the output voltage of the power source 21 can be decreased and the voltage drops in the current sources 22R, 22G, and 22B can be decreased, so that the electric power consumption can be reduced.

In the above embodiment, although the electroluminescence display panel in which a plurality of organic electroluminescence devices are arranged in matrix form as a capacitive light emitting device panel has been shown, the present invention is not limited to it but the present invention can be also applied to another capacitive light emitting device panel.

The present invention is not limited to the capacitive light emitting device panel of the simple matrix system but can be also applied to a capacitive light emitting device panel of an active matrix system.

As mentioned above, according to the capacitive light emitting device panel of the color display of the present invention, since wasteful electric power consumption of the driving circuit can be reduced, the power saving can be realized.

This application is based on a Japanese Patent Application No. 2001-265668 which is hereby incorporated by reference.

What is claimed is:

1. A capacitive light emitting device panel having a plurality of pixels each of which is constructed by a red light emitting unit, a green light emitting unit, and a blue light emitting unit, wherein
a ratio of areas of light emitting surfaces of said red light emitting unit, said green light emitting unit, and said blue light emitting unit is set so that voltage differences among peak voltages of applied voltages to said red light emitting unit, said green light emitting unit, and said blue light emitting unit lie within a predetermined voltage range.

2. A panel according to claim 1, wherein the area of the light emitting surface of said blue light emitting unit is the smallest.

3. A panel according to claim 1, wherein the area of the light emitting surface of said red light emitting unit is the largest.
